(19) United States
(12) Patent Application Publication
(10) Pub. No.: US 2022/0305445 A1
(43) Pub. Date: Sep. 29, 2022

(54) METHOD OF TREATING OIL-CONTAINING DISCHARGED WATER

(71) Applicant: Nitto Denko Corporation, Ibaraki-shi, Osaka (JP)

(72) Inventor: Nagahisa SATO, Ibaraki-shi, Osaka (JP)

(21) Appl. No.: 17/603,552

(22) PCT Filed: Jul. 20, 2021
(86) PCT No.: PCT/JP2021/027189

§ 371 Date: Oct. 13, 2021

(30) Foreign Application Priority Data
Sep. 8, 2020 (JP) 2020-150765

(51) Int. Cl. B01D 69/02; B01D 61/02; B01D 71/32; B01D 71/64; B01D 69/12; C02F 1/44

(52) U.S. Cl. CPC B01D 69/02; B01D 61/025; B01D 71/32; B01D 71/64; B01D 69/12; C02F 1/441; B01D 2325/02; C02F 2101/322

(57) ABSTRACT

A to-be-treated liquid containing oil that is obtained from oil-containing discharged water is treated with an oil-resistant separation membrane to remove the oil.

### TECHNICAL FIELD

The present invention relates to a method of treating oil-containing discharged water.

### BACKGROUND ART

Oil-containing discharged water, such as produced water, includes inorganic solid materials, such as sand, as well as various substances, such as oil and salt. If such oil-containing discharged water is disposed in an untreated state, the environmental load increases. Thus, it is desired to remove contained substances as much as possible from the oil-containing discharged water before disposal. In recent years, it is also required to treat and reuse the oil-containing discharged water, and thus it is required to purify the oil-containing discharged water to be in a state at a high standard in which the oil-containing discharged water can ultimately be accepted as reuse water.

In order to purify the oil-containing discharged water, removal units or processes suitable for removing respective substances contained in the oil-containing discharged water are combined, and multistage treatments are performed.

For example, Patent Document 1 describes a method of treating produced water in which at least an aggregating process of aggregating emulsified oil contained in the produced water by introducing micronanobubbles consisting of an ozone-containing gas into the produced water, and a flotation separation process of obtaining purified water by causing the aggregated oil to float as scum are performed, after an oil separation process of removing free oil. Additionally, it is described that the obtained purified water may be desalted.

Patent Document 2 describes that an oil/water mixture is treated in stages with a free water knock out, a treater, and the like, and deoiling is performed on the obtained oil-containing treated liquid and then separated into permeated water and concentrated water by causing the obtained oil-containing treated liquid to pass through a membrane system.

### RELATED ART DOCUMENTS

### Patent Document

[Patent Document 1] WO 2013/129159
[Patent Document 2] WO 2010/135020

### SUMMARY OF THE INVENTION

### Problem to be Solved by the Invention

Patent Document 1 and Patent Document 2 describe that a process using a separation membrane is performed after the deoiling process. However, with conventional methods, if the treatment continues for a long period of time, the separation membrane may deteriorate early and there is a case in which desalting cannot be performed with good treatment efficiency. With respect to the above, additional treatment to thoroughly remove oil of all kinds may be costly or the environmental load may increase due to discharged water generated by the additional treatment and the like.

Therefore, in view of the above, one aspect of the present invention is to provide a method of treating oil-containing discharged water with good treatment efficiency over a long period of time with low cost and low environmental load.

### Means for Solving the Problem

According to one aspect of the invention, a method of treating oil-containing discharged water, in which to-be-treated liquid containing oil obtained from the oil-containing discharged water is treated with an oil-resistant separation membrane, so that the oil is removed, is provided.

### Advantageous Effect of the Present Invention

According to one aspect of the present invention, a method of treating oil-containing discharged water with good treatment efficiency over a long period of time with low cost and low environmental load can be provided.

### BRIEF DESCRIPTION OF THE DRAWINGS

FIG. 1 illustrates a schematic diagram of a treatment apparatus that performs a treatment method according to an embodiment of the present invention; and

FIG. 2 illustrates a schematic cross-sectional view of a reverse osmosis membrane used in the embodiment of the present invention.

### EMBODIMENTS FOR CARRYING OUT THE INVENTION

The oil-containing discharged water treated in the present embodiment is not particularly limited, as long as the discharged water contains oil, regardless of a place where the discharged water is obtained or a way how the discharged water is obtained. In most cases, the oil-containing discharged water does not merely contain oil, but may also contain various materials other than oil, regardless of whether inorganic or organic materials, in a dispersed or dissolved state, or in separate phases.

The oil-containing discharged water includes, for example, produced water. The produced water is also referred to as produced water with resource mining, and is an aquatic liquid produced in the course of mining resources such as oil and gas. More specifically, the produced water is discharged water that is left after the target natural resources (oil, gas, and the like) are obtained separately. Examples of the oil-containing discharged water other than the produced water include wash water and wet air oxidation-treated water. The wash water is discharged water generated when crude oil separated at a crude oil mining site is cleaned (crude oil cleaning discharged water). Additionally, the wet air oxidation-treated water is discharged water generated by wet air oxidation (WAO) during production of natural resource gas or a petroleum refining process. In the wet air oxidation, treatment using alkali and the like is often performed, and the wet air oxidation-treated water often contains relatively large amounts of inorganic salts.

In the present specification, the oil generally refers to hydrophobic substances, that is, substances that can dissolve in water but tend not to easily dissolve. The oil of the oil-containing discharged water can be classified as: (i) free oil that floats in a liquid or in an upper layer of a liquid in a size large enough to be visible; (ii) emulsion oil that disperses or emulsifies in a liquid in a size that cannot be easily visually found; and (iii) a dissolved oil that is dissolved in water. The dissolved oil, unlike free oil or emulsion oil, is not easily sieved based on the size. The type of the dissolved oil is not particularly limited, and the dissolved oil may be a low molecular weight organic compound dissolved in the oil-containing discharged water, or a volatile organic solvent. The dissolved oil may be a non-polar organic solvent dissolved in the oil-containing discharged water. Representative examples of the dissolved oil include aromatic hydrocarbons, and more specifically BTEX. BTEX is a generic term for benzene, toluene, ethylbenzene, and xylene. That is, the aromatic hydrocarbons described above may include one or more of benzene, toluene, ethylbenzene, and xylene, or may be one or more of benzene, toluene, ethylbenzene, and xylene.

If the treatment is performed by using a separation membrane, it has been recognized that the separation membrane is likely to deteriorate due to the free oil and the emulsion oil among the above-described oil. However, the inventor has found that the deterioration of the separation membrane is also caused by the dissolved oil, and has achieved the present invention.

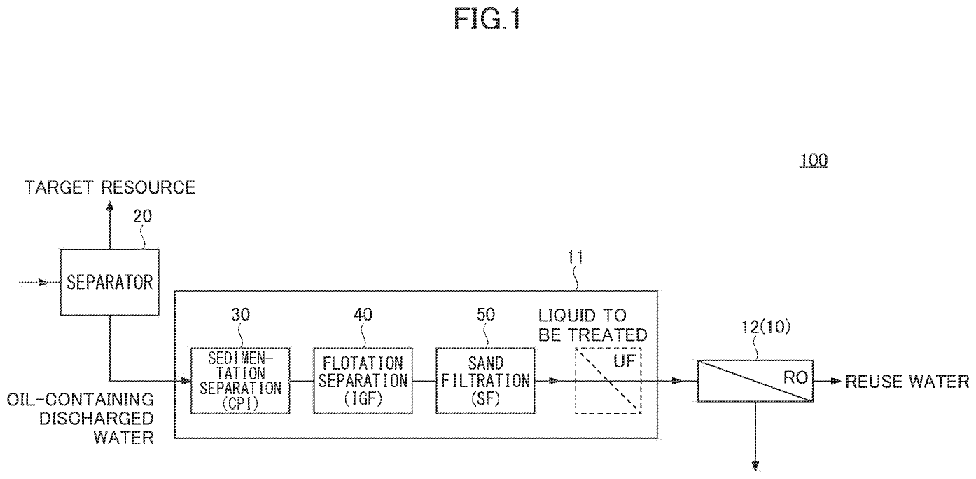

FIG. 1 schematically illustrates a treatment apparatus 100 for the produced water as a treatment apparatus for the oil-containing discharged water according to the present embodiment. In the treatment apparatus 100 according to the present embodiment illustrated in FIG. 1, a target resource (e.g., oil, gas, or the like) is first separated by, for example, the separator 20, from the acquisitions obtained by resource mining, and the produced water (i.e., the oil-containing discharged water) is provided to a pretreatment unit 11.

The pretreatment unit 11 includes a sedimentation separation unit 30, a flotation separation or induced gas flotation (IGF) unit 40, and a sand filtration (SF) unit 50. In the example illustrated in FIG. 1, the produced water (i.e., the oil-containing discharged water) is pretreated in stages by sequentially passing the produced water through these units.

The sedimentation separation unit 30 is a unit that separates oil and water by utilizing gravity, and uses, for example, an oil separator such as a corrugated plate interceptor (CPI) or the like. The sedimentation separation unit 30 can mainly separate and remove the free oil.

The flotation separation unit 40 is a step of causing oil and solids to float and collecting the oil and solids by using microbubbles. The emulsion oil that has not been removed in the sedimentation separation unit 30 can be separated and removed.

The sand filtration unit 50 is a unit that further reduces the oil. In the sand filtration unit 50, for example, a multimedia filter (MMF) that includes two or more layers of sand filtration materials may be used. The sand filtration unit 50 can further remove the emulsion oil and fine solids.

The oil contained in the produced water (i.e., the oil-containing discharged water) can be removed to some extent by the pretreatment unit 11, which includes the sedimentation separation unit 30, the flotation separation unit 40, and the sand filtration unit 50. However, what can be removed by the pretreatment unit 11 is mainly the free oil and the emulsion oil. Therefore, even in a state after the treatment with the pretreatment unit 11, the dissolved oil mostly remains.

As illustrated in FIG. 1, according to the present embodiment, a separation membrane unit 12 that performs the filtration separation by using a separation membrane is connected directly after the pretreatment unit 11. The separation membrane used in the separation membrane unit 12 may be oil resistant. By using such an oil-resistant separation membrane, stable treatment can be continuously performed over a long period of time without the occurrence of leak spots or delamination of the separation membrane, even if the dissolved oil is contained in the to-be-treated liquid. The oil resistance of the separation membrane can be obtained by a certain structure, that is, a structure having a porous support layer that mainly contains one or more of a fluoropolymer and an imide-containing polymer, as described below.

In other words, a method of treating the oil-containing discharged water according to the present embodiment is such that the to-be-processed liquid, obtained through the pretreatment unit 11, in which the dissolved oil mostly remains, can be treated with a reverse osmosis membrane, without treatment to reduce the dissolved oil. More specifically, treated water having an oil concentration of 0.1 mg/L or greater can be introduced to the separation membrane unit 12 and treated.

As described, in the present embodiment, a unit for reducing or removing the dissolved oil (a dissolved oil reducing unit) is not required before the treated liquid is introduced into the separation membrane unit 12. Examples of the dissolved oil reducing unit include ultrafiltration (UF) membranes. As a preferred example, FIG. 1 illustrates a configuration in which the UF membrane, which is the dissolved oil reducing unit, is omitted. However, the apparatus according to the present embodiment does not completely eliminate the dissolved oil reducing unit before the separation membrane unit 12, and the method according to the present embodiment does not completely eliminate a process of reducing the dissolved oil before the treatment with the oil-resistant separation membrane. In the above-described dissolved oil reducing unit, a microfiltration membrane, other than a UF membrane, having a pore diameter of about 0.05 μm to 10 μm may be used, and, for example, an inorganic membrane made of a ceramic, or a means other than a membrane such as distillation, adsorption, or a chemical may be used.

Furthermore, it is preferable that the separation membrane used in the separation membrane unit 12 is an oil resistant reverse osmosis membrane. In this case, removal of oil and removal of salt (desalting) can be performed by a single process of passing the to-be-treated liquid through the reverse osmosis membrane. In other words, the present embodiment may include performing the removal of oil and desalting simultaneously. More specifically, the present embodiment may include performing the removal of the dissolved oil and desalting simultaneously, and more specifically, performing the removal of non-polar aromatic hydrocarbons dissolved in the treated water and desalting simultaneously.

By using the oil-resistant reverse osmosis membrane, the treated liquid (i.e., the treated water) obtained from the oil-containing discharged water can be purified by a single membrane treatment to be reuse water with a significant reduction in both oil and salt. Therefore, because the treatment performed by the dissolved oil reducing unit (e.g., UF film or the like) can be omitted, the treatment cost can be reduced. Additionally, because the discharged water generated by the dissolved oil reducing unit can be reduced, the environmental load can be reduced. Further, agents that chemically denature or degrade the dissolved oil are not required, and the handling of the agents, which is potentially cumbersome, and the treatment of products by denaturing or degrading the dissolved oil are not required. Thus, the treatment cost and the environmental load can be reduced. More specifically, the method according to the present embodiment may include treating the to-be-treated liquid with an oil resistant reverse osmosis membrane without degrading the dissolved oil with the agent. Here, it is preferable that the agents are other than surfactant agents. Additionally, more specifically, the method according to the present embodiment may include treating the to-be-treated liquid with an oil resistant separation membrane without adding an agent that chemically denatures at least the aromatic hydrocarbons.

According to the present embodiment, the post-treatment water obtained through the separation membrane unit 12 is reusable water for many purposes (reuse water), and contains little or no impurities (including solid substances, oil, and salts) or at low concentration if included.

The oil concentration in the to-be-processed liquid to be introduced into the separation membrane unit 12 according to the present embodiment can be 0.1 mg/L or more, as described above. Additionally, according to the present embodiment, the treatment can be performed even if the oil concentration is 1 mg/L or greater, and further, even if 100 mg/L or greater. Additionally, if the concentration of the dissolved oil in the to-be-processed liquid is 0.1 mg/L or greater, 1 mg/L or greater, or 100 mg/L or greater, the treatment can be performed. Furthermore, if the separation membrane used in the separation membrane unit 12 is a reverse osmosis membrane, desalting can be performed with a high blocking ratio even if the oil concentration (or the concentration of the dissolved oil) is 0.1 mg/L or greater, 1 mg/L or greater, or 100 mg/L or greater.

If the separation membrane that is used is a reverse osmosis membrane, the treatment by the separation membrane unit 12 can be performed under a pressure of 0.3 MPa or greater. Such an operating pressure may be 2 MPa or greater, 4 MPa or greater, or 5 MPa or greater.

Here, FIG. 1 is a mere example of the treatment apparatus and one or more treatment units may be removed from or modified from the apparatus illustrated in the diagram, or one or more additional treatment units or treatment means may be added to the apparatus illustrated in the diagram, or the order of the treatment units illustrated in FIG. 1 may be changed without departing from the scope of the claims. For example, the configuration of the pretreatment unit 11 is not limited to the sedimentation separation unit 30, the flotation separation unit 40, and the sand filtration unit 50 described above, and a known configuration can be used for the pretreatment unit before the separation membrane unit 12, as long as the free oil and the emulsion oil can be reduced or eliminated.

Additionally, a hardness removing unit that removes or reduces hardness may be provided between the above-described units, for example, between the flotation separation unit 40 and the sand filtration unit 50, or between the sand filtration unit 50 and the separation membrane unit 12. The hardness removing unit is a unit that reduces hardness components (e.g., calcium ions and magnesium ions), and may be, for example, a unit that removes the hardness components by adding a chemical agent for deposition. Further, in the treatment method according to the present embodiment, a temperature adjusting unit that performs a temperature adjustment by using a heat exchanger may be provided at any of the above-described processes.

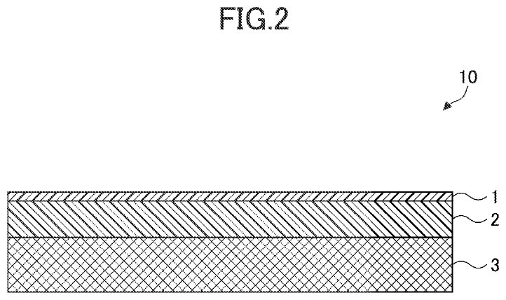

In the following, the separation membrane 10 used in the separation membrane unit 12 (FIG. 1) used in the treatment method of the present embodiment will be described with reference to a reverse osmosis membrane as an example. FIG. 2 illustrates a schematic cross-sectional view of the reverse osmosis membrane (separation membrane) 10. As illustrated in FIG. 2, the reverse osmosis membrane 10 includes a porous support layer 2 and a separation function layer (an active layer or a skin layer) 1 provided on the porous support layer 2. Additionally, the reverse osmosis membrane 10 may include a substrate 3 for reinforcing the porous support layer 2, as illustrated in FIG. 2.

The separation function layer in the reverse osmosis membrane is an extremely thin layer provided at the top of the reverse osmosis membrane. The porous support layer serves to support the separation function layer.

The porous support layer is a polymer porous layer, that is, a porous layer that consists of a polymer (organic polymer or organic polymer compound) or that mainly contains a polymer as a main component. The polymer in the porous support layer may mainly contain one or more of a fluoropolymer and an imide-containing polymer. That is, the polymer in the porous support layer may contain a fluoropolymer, an imide-containing polymer, or a combination of the fluoropolymer and the imide-containing polymer. Here, in the present specification, “a predetermined material is a main component of” or “mainly contain a predetermined material” indicates that the predetermined material is contained at 50% by weight or greater.

A fluoropolymer or an imide-containing polymer contained in the polymer in the porous support layer relative to the total amount of the polymer may be, preferably 80% by weight or greater, more preferably 90% by weight or greater, still more preferably 95% by weight or greater, still more preferably 99% by weight or greater, and still more preferably 99.5% by weight or greater. Additionally, the polymer in the porous support layer is preferably substantially formed by a fluoropolymer or an imide-containing polymer. In the present specification, the term “substantially formed by” indicates that the inclusion of components other than the predetermined component that are unavoidably generated or mixed in during production is allowed.

The oil resistance of the porous support layer can be improved by the polymer in the porous support layer containing one or more of a fluoropolymer and an imide-containing polymer. Additionally, as described below, the porous support layer having high pressure resistance can be formed. Therefore, even if the amount of the oil contained in the to-be-treated liquid is relatively high, the treatment can be efficiently performed without deterioration of the porous support layer.

The fluoropolymer is a fluorine-containing polymer. The fluoropolymer can be a homopolymer or a copolymer. For example, the fluoropolymer may be a homopolymer or copolymer of polyvinylidene fluoride (PVDF), polytetrafluoroethylene (PTFE), polyvinyl fluoride (PVF), polychlorotrifluoroethylene (PCTFE), and the like. Here, the copolymer is obtained by copolymerizing another monomer unit to a monomer unit of a main component in the fluoropolymer copolymer. The weight of the monomer unit of the main component based on the weight of the fluoropolymer copolymer is 50% by weight or greater, preferably 70% by weight or greater, and more preferably 80% by weight or greater. Therefore, for example, a polyvinylidene fluoride copolymer indicates that a vinylidene fluoride monomer unit (a monomer unit derived from vinylidene fluoride) contained in the polyvinylidene fluoride copolymer based on the weight of the polyvinylidene fluoride copolymer is 50% by weight or greater, preferably 70% by weight or greater, more preferably 80% by weight or greater, and still more preferably 90% by weight or greater.

Among the above-described specific examples of fluoropolymers, in view of excellent workability, excellent pressure resistance, and chemical resistance (including oil resistance), a polyvinylidene fluoride homopolymer, a polyvinylidene fluoride copolymer, or a mixture of both is preferably contained, and a polyvinylidene fluoride copolymer is more preferably contained. Thus, the polymer in the porous support layer preferably mainly contains a polyvinylidene fluoride homopolymer and/or a polyvinylidene fluoride copolymer. Additionally, a polyvinylidene fluoride homopolymer and/or a polyvinylidene fluoride copolymer contained in the polymer in the porous support layer based on the total amount of the polymer, is preferably 80% by weight or greater, more preferably 90% by weight or greater, still more preferably 95% by weight or greater, still more preferably 99% by weight or greater, and still more preferably 99.5% by weight or greater. Furthermore, it is preferable that the polymer in the porous support layer is substantially formed by a polyvinylidene fluoride homopolymer and/or a polyvinylidene fluoride copolymer.

If the fluoropolymer is a copolymer, another monomer unit that is copolymerized with a monomer unit of the main component may be a monomer unit of the above-described fluoropolymer, a monomer unit of a fluoropolymer other than the above-described fluoropolymer, or a monomer component that is not a fluoropolymer (a fluorine-free monomer component). If the crystalline polymer in the present embodiment is a polyvinylidene fluoride copolymer, another monomer unit that is copolymerized is preferably a monomer unit derived from hexafluoropropylene, tetrafluoroethylene, and chlorotrifluoroethylene. More preferably, another copolymerized monomer unit contains a monomer unit derived from hexafluoropropylene. That is, if the crystalline polymer contains a vinylidene fluoride copolymer, the vinylidene fluoride copolymer is preferably a vinylidene fluoride-hexafluoropropylene copolymer containing a monomer unit derived from vinylidene fluoride and a monomer unit derived from hexafluoropropylene. Additionally, if the polyvinylidene fluoride copolymer contains a monomer unit derived from hexafluoropropylene as another monomer unit, the weight of the monomer unit derived from hexafluoropropylene based on the total weight of the polyvinylidene fluoride copolymer may be preferably 20% by weight or less, more preferably 15% by weight or less, and still more preferably 10% by weight or less.

The manner of polymerizing the copolymer is not limited. The polymerization may be a graft copolymer, a block copolymer, a random copolymer, or the like. Also, examples of the fluoropolymer copolymer include perfluoroalkoxyalkanes (ethylene tetrafluoride-perfluoroalkoxyethylene copolymers, PFA), perfluoroethylene propene copolymers (ethylene tetrafluoride-propylene hexafluoride copolymers, FEP), ethylene tetrafluoroethylene copolymers (ethylene tetrafluoride-ethylene copolymers, ETFE), ethylene chlorotrifluoroethylene copolymers (ethylene trifluoride-ethylene copolymers, ECTFE), and the like.

Further, regardless of whether the above-described fluoropolymer is a homopolymer or a copolymer, the above-described fluoropolymer may be arbitrarily combined polymer blends (polymer alloys) of two or more species. Polymers of different molecular weights can also be used in combination as the above-described fluoropolymer. For example, a mixture of two or more polyvinylidene fluoride homopolymers having different average molecular weights may be used, a mixture of two or more polyvinylidene fluoride copolymers having different average molecular weights may be used, or a mixture of a polyvinylidene fluoride homopolymer and a polyvinylidene fluoride copolymer, in which these average molecular weights are different, may be used.

If the polymer in the porous support layer contains a fluoropolymer, the crystallinity of the fluoropolymer may be 50% or less, preferably less than 50%, more preferably 48% or less, and still more preferably 45% or less. By making the crystallinity of the fluoropolymer 50% or less, the amorphous portion of the fluoropolymer exceeds 50% and the porous support layer can be provided with adequate flexibility, thereby increasing the toughness of the entire porous support layer. By having such a structure, a porous layer that is resistant to breakage under pressure can be obtained. Additionally, the lower limit of the crystallinity of the fluoropolymer is not particularly limited, but may be 30% or greater, preferably 32% or greater. If the crystallinity is 30% or greater, sufficient strength can be secured, and thus a porous layer that is resistant to deformation even when pressure is applied can be obtained. Therefore, by making the crystallinity of the fluoropolymer greater than or equal to 30% and smaller than or equal to 50%, a reverse osmosis membrane having high resistance to pressure can be obtained. The crystallinity can be calculated by measuring the melting heat quantity by differential scanning calorimetry (DSC).

Additionally, if the polymer in the porous support layer contains a fluoropolymer, the weight average molecular weight of the fluoropolymer is preferably 400,000 or greater and 2,000,000 or less, more preferably greater than 400,000 and 2,000,000 or less, and still more preferably 450,000 or greater and 1,500,000 or less. If the weight average molecular weight of the polymer is 400,000 or greater, a porous support layer having a moderate thickness can be formed during production of the reverse osmosis membrane, thereby obtaining suitable strength of the porous support layer that is formed. If the weight average molecular weight of the polymer is 2,000,000 or less, it is easier to handle the polymer during production, thereby providing suitable flexibility in the porous support layer that is formed.

The imide-containing polymer is a material that is excellent in heat resistance in addition to chemical resistance (including oil resistance) and pressure resistance, and easy for processing. Thus, imide-containing polymer is preferably used. The imide-containing polymer may be a polymer containing one or more imide bonds in the monomer unit constituting the polymer. Examples of the imide-containing polymer include polyetherimide (PEI), polyamideimide (PAI), polyimide (PI), and the like. Examples of the polyetherimide (PEI) include “Ultem (registered trademark) 1000” manufactured by SABIC Innovative Plastics. Examples of the polyamide imide (PAI) include “Torlon (registered trademark) AI-10” manufactured by Solvay, and “Viromax (registered trademark) HR-22BL” manufactured by Toyobo Co., Ltd. Examples of the polyimide (PI) include “KPI-MX300F” manufactured by Kawamura Sangyo Co., Ltd. and “P84 (registered trademark)” manufactured by EVONIK.

The imide-containing polymer may be a homopolymer or a copolymer. If the imide-containing polymer is a copolymer, the weight of the monomer unit of the main component may be 50% by weight or greater, preferably 70% by weight or greater, and more preferably 80% by weight or greater based on the total weight of the imide-containing polymer. The manner of polymerizing the copolymer is not limited. The polymerization may be a graft copolymer, a block copolymer, a random copolymer, or the like.

Further, regardless of whether the imide-containing polymer described above is a homopolymer or a copolymer, the imide-containing polymer may be arbitrarily combined polymer blends (polymer alloys) of two or more species. Additionally, polymers having different molecular weights can be used as the imide-containing polymer described above. For example, a mixture of two or more polyetherimide homopolymers having different average molecular weights may be used, a mixture of two or more polyetherimide copolymers having different average molecular weights may be used, or a mixture of a polyetherimide homopolymer and a polyetherimide copolymer having different average molecular weights may be used.

If the polymer in the porous support layer contains an imide-containing polymer, the weight average molecular weight of the imide-containing polymer is preferably 10,000 or greater and 100,000 or less, and more preferably 20,000 or greater and 80,000 or less. By making the weight average molecular weight of the imide-containing polymer greater than or equal to 10,000, suitable workability can be obtained. Additionally, by making the weight average molecular weight of the imide-containing polymer less than or equal to 100,000, the strength of the porous support layer, and then the strength of the reverse osmosis membrane can be improved.

It is preferable that the polymer included in the porous support layer is substantially free of polysulfone. In the present specification, the term “substantially free” of a predetermined component indicates that the amount of the predetermined component relative to the total amount of polymer is 3% by weight or less, preferably 1% by weight or less, more preferably 0.5% by weight or less, still more preferably 0.1% by weight or less, and still more preferably 0% by weight, that is, containing no predetermined component. The polymer in the porous support layer is substantially free of polysulfone, thereby improving oil resistance of the reverse osmosis membrane. Therefore, if the to-be-treated liquid containing oil is desalinated by using the reverse osmosis membrane according to the present embodiment, continuous desalination can be performed without leak spots being formed in the porous support layer or delamination occurring between the porous support layer and the separation function layer. Additionally, the polymer contained in the porous support layer in the present specification is more preferably substantially free of polymers having a sulfonyl group, such as polyethersulfone, polyphenylsulfone, and the like.

The porous support layer in the present embodiment may be homogeneous or heterogeneous as a whole. Here, the porous support layer is preferably a homogeneous layer as a whole.

Further, the porous support layer may contain additives and the like as components other than the polymer. Additives that may be contained in the porous support layer as components other than the polymer include functional particles, such as colloidal silica, zeolites, and the like.

Further, in the present embodiment, the compression rate of a portion including the porous support layer and the separation function layer of the reverse osmosis membrane 10 when subjected to a pressure of 5.5 MPa may be 0.1% or greater and 60% or less, preferably 1.0% or greater and 50% or less, and preferably 1.0% or greater and 40% or less.

The above-described compression ratio of the portion including the porous support layer and the separation function layer is the ratio of the reduced thickness due to compression over a predetermined period of time under a predetermined pressure (i.e., a value obtained by subtracting the thickness after pressurization from the initial thickness) to the initial thickness. The predetermined period of time may be 2 hours or more. Thus, for example, the above-described compression ratio can be a compression ratio of the portion including the porous support layer and the membrane separation layer when subjected to a pressure of 5.5 MPa for 2 hours. Additionally, the above-described compression ratio can be a compression ratio after forming a composite semipermeable membrane including the porous support layer and the membrane separation layer, and treating the to-be-treated liquid at a pressure of 5.5 MPa for 2 hours.

As described, the portion including the porous support layer and the separation function layer according to the present embodiment has a compression ratio in the range described above, and exhibits excellent pressure resistance. Thus, the portion including the porous support layer and the separation function layer according to the present embodiment can be used under conditions of high operating pressure. For example, in the reverse osmosis membrane according to the present embodiment, even when an operating pressure, for example, 1 to 12 MPa is applied, structural changes of the porous support layer can be minimized, and the salt blocking ratio (i.e., the removal rate of salt) can be maintained for a long period of time.

A method of producing the porous support layer according to the present embodiment is not particularly limited. Although a non-solvent-induced phase separation method (NIPS), a thermally-induced phase separation (TIPS), or the like can be used, a non-solvent-induced phase separation method (NIPS) is preferably used because a uniform and wide porous support layer can be produced. More specifically, after the above-described polymer is dissolved in a solvent to obtain a membrane-forming solution, the membrane-forming solution is applied to a substrate such as a non-woven fabric, with a knife coater or the like. Subsequently, the substrate is placed under high humidity so as to generate a microphase separation, and the polymer in the applied solution is then caused to solidify and the residual solution is removed.

In producing the porous support layer by using the non-solvent induced phase separation method described above, the polymer is dissolved in a solvent. Because a homogenous membrane-forming solution can be formed and a favorable microphase separation can be generated in a portion where the solution is applied, the solvent to be used is preferably a water-soluble solvent and has a high boiling point. For example, the solvent to be used is preferably a water-soluble solvent having a boiling point of 130° C. or higher and 250° C. or lower. Examples of the solvent include dimethylformamide (DMF), dimethylsulfoxide (DMSO), dimethylacetamide (DMAC), 1,3-dimethyl-2-imidazolidinone (DMI), N-methylpyrrolidone (NMP), γ-butyrolactone (GBL), and the like. In other words, the crystalline polymer used in the present embodiment is preferably soluble in the above-mentioned solvent and can be dissolved in the solvent at the temperature from room temperature to about 80° C. to obtain a homogenous membrane-forming solution.

In producing the membrane-forming solution, in addition to the above solvent, polyoxyalkylene such as polyethylene glycol, polybutylene glycol, and the like; water-soluble polymers such as polyvinyl alcohol, polyvinyl butyral, and the like; glycerin; diethylene glycol; water; acetone; 1,3-dioxolane; and the like may be added as a porous agent. The porosity, pore diameter, and the like in the porous support layer can be adjusted by adding a predetermined amount of the porous agent.

Additionally, the void ratio (the porosity) of the porous support layer before applying pressure in the present embodiment is preferably 30% or greater and 70% or less and more preferably 40% or greater and 50% or less. If the porosity of the porous support layer is 30% or greater, the water permeability and desalting ability of the reverse osmosis membrane can be ensured. Additionally, if the porosity of the porous support layer is 70% or less, the pressure resistance and the strength of the porous support layer and then the pressure resistance and the strength of the reverse osmosis membrane can be improved, and the permeation performance of the permeable flux and the like can be improved. Furthermore, even when the porous support layer is compressed by the application of pressure for a long period of time or at high pressure, high permeability can be maintained. Here, the porosity of the porous support layer can be measured based on the weight of the porous support layer with pores of the porous support layer filled with pure water.

Further, it is preferable that the porosity of the porous support layer after pressurization, e.g., after pressurization at a pressure of 5.5 MPa for 2 hours, is 30% or greater and 60% or less.

The average pore size on the surface of the porous support layer is preferably 5 nm or greater and 50 nm or less, and more preferably 15 nm or greater and 25 nm or less.

The separation function layer may be a layer including a crosslinked polyamide. The crosslinked polyamide separation function layer is obtained by interfacial polymerization of a multifunctional amine and an acid halide compound.

The polyfunctional amine may be an aromatic polyfunctional amine, an aliphatic polyfunctional amine, or a combination of the aromatic polyfunctional amine and the aliphatic polyfunctional amine. The aromatic polyfunctional amine may be m-phenylenediamine, p-phenylenediamine, 1,3,5-triaminobenzene, and the like, or N-alkylates thereof, such as N,N-dimethyl m-phenylenediamine, N,N-diethyl m-phenylenediamine, N,N-dimethyl p-phenylenediamine, or N,N-diethyl p-phenylenediamine. The aliphatic polyfunctional amine may be piperazine or a derivative thereof. Specific examples of the aliphatic polyfunctional amine include piperazine, 2,5-dimethylpiperazine, 2-methylpiperazine, 2,6-dimethylpiperazine, 2,3,5-trimethylpiperazine, 2,5-diethylpiperazine, 2,3,5-triethylpiperazine, 2-n-propylpiperazine, 2,5-di-n-butylpiperazine, ethylenediamine, and the like. These polyfunctional amines can be used alone or in combination of two or more.

The acid halide compound is not particularly limited as long as the acid halide compound provides a polyamide by a reaction with the above-described polyfunctional amine. An acid halide having two or more carbonyl halides in one molecule is preferably used.

Specific examples of the acid halide compound include an acid halide compound of a fatty acid such as oxalic acid, malonic acid, maleic acid, fumaric acid, glutaric acid, 1,3,5-cyclohexanetricarboxylic acid, 1,3-cyclohexanedicarboxylic acid, 1,4-cyclohexanedicarboxylic acid, and the like; an acid halide compound of an aromatic acid such as phthalic acid, isophthalic acid, 1,3,5-benzenetricarboxylic acid, 1,2,4-benzenetricarboxylic acid, 1,3-benzenedicarboxylic acid, 1,4-benzenedicarboxylic acid, and the like. These acid halide compounds can be used alone or in combination of two or more species.

When the separation function layer is formed, the porous support layer is formed on a substrate, and then a surface of the porous support layer is immersed in a solution of a polyfunctional amine compound. Subsequently, the porous support layer is caused to contact a solvent solution of an acid halide compound to form a crosslinked polyamide layer by performing an interfacial polymerization.

Examples of the substrate in the reverse osmosis membrane include a fibrous planar structure, specifically, a woven fabric, a knitted fabric, a non-woven fabric, and the like. Among these, a non-woven fabric is preferably used. The non-woven fabric may be made by a spunbond process, a spunlace process, a meltblown process, a carding process, an air-lay process, a wet process, a chemical bond process, a thermal bond process, a needle punch process, a water jet process, a stitch bond process, an electrospinning process, and the like. Also, although the type of fibers constituting the non-woven fabric is not limited, the fibers constituting the non-woven fabric are preferably synthetic fibers. Specific examples of the fibers may be polyethylene terephthalate (PET), polybutylene terephthalate (PBT), polytrimethylene terephthalate (PTT), polyethylene naphthalate (PEN), polypropylene (PP), polyethylene (PE), polyphenylene sulfide (PPS), polyvinylidene fluoride (PVDF), polyglycolic acid (PGA), polylactic acid (PLA), nylon 6, polycaprolactone (PCL), polyethylene adipate (PEA), polyhydroxyalkanoate (PHA), or a copolymer thereof. Among these, a polyester such as polyethylene terephthalate, is preferably used because polyethylene terephthalate is inexpensive, has high dimensional stability, is highly moldable, and has high oil resistance.

The thickness of the reverse osmosis membrane according to the present embodiment may be 100 μm or greater and 250 μm or less. The thickness of the porous support layer may be 10 μm or greater and 100 μm or less. The thickness of the separation function layer may be 0.01 μm or greater and 1 μm or less. The thickness of the substrate may be 50 μm or greater and 200 μm or less.

It is preferable that the reverse osmosis membrane according to the present embodiment is configured as a flat membrane. Additionally, the flat membrane according to the present embodiment may be suitably used as a spiral type membrane module that is formed by spirally winding the reverse osmosis membrane on the outside of a water collection tube.

The oil removal ratio of the reverse osmosis membrane according to the present embodiment may be preferably 60% or greater, more preferably 70% or greater, and still more preferably 80% or greater. The above-described oil removal ratio can be expressed as (1−Co2/Co1)×100 when the oil concentration of a liquid to be treated by using the reverse osmosis membrane is defined as Co1 and the oil concentration of a permeated liquid obtained after the treatment with the reverse osmosis membrane is defined as Co2. In the reverse osmosis membrane according to the present embodiment, the oil removal ratio can be maintained even when the treatment continues for 10 hours or greater or 20 hours or greater.

The salt blocking ratio at the reverse osmosis membrane is preferably 85% or greater, more preferably 90% or greater, and still more preferably 95% or greater. The above-described salt blocking ratio can be expressed as (1−Ci2/Ci1)×100 when the salt concentration of a liquid to be treated with the reverse osmosis membrane is Ci1 and the salt concentration of a permeated liquid obtained after the treatment with the reverse osmosis membrane is Ci2. For example, the reverse osmosis membrane may have the above values of the NaCl blocking ratio. Alternatively, the salt blocking ratio can be expressed as (1−o2/o1)×100 when the conductivity of a liquid to be treated with the reverse osmosis membrane is o1 and the conductivity of a permeated liquid obtained after the treatment with the reverse osmosis membrane is o2. The blocking ratio of the salt may be a value measured at the room temperature (25° C.).

In the following, a specific embodiment of the present invention will be appended below.

(Appendix 1) With respect to a method of treating oil-containing discharged water, the method includes treating a to-be-treated liquid containing oil with an oil-resistant separation membrane to remove the oil, the to-be-treated liquid being obtained from oil-containing discharged water.

(Appendix 2) The method of treating the oil-containing discharged water, described in Appendix 1, is provided, wherein the oil-resistant separation membrane is a reverse osmosis membrane, and the removing of the oil and desalting are performed simultaneously.

(Appendix 3) The method of treating the oil-containing discharged water, described in Appendix 1 or 2, is provided, wherein the oil is dissolved oil.

(Appendix 4) The method of treating the oil-containing discharged water, described in any one of Appendixes 1 to 3, is provided, wherein the concentration of the oil in the to-be-treated liquid is 0.1 mg/L or greater.

(Appendix 5) The method of treating the oil-containing discharged water, described in any one of Appendixes 1 to 4, is provided, wherein the oil-containing discharged water is one or more of produced water, wash water, and wet air oxidation-treated water.

(Appendix 6) The method of treating the oil-containing discharged water, described in any one of Appendixes 1 to 5, is provided, wherein the oil removal ratio of the oil-resistant separation membrane is 60% or greater, and the oil removal ratio is (1−Co2/Co1)×100, when the concentration of the oil of the to-be-treated liquid to be treated by using the oil-resistant separation membrane is Co1 and the concentration of the oil of a permeated liquid obtained after the treatment with the oil-resistant separation membrane is Co2.

(Appendix 7) The method of treating the oil-containing discharged water, described in any one of Appendixes 1 to 6, is provided, wherein the salt blocking ratio of the oil-resistant separation membrane is 85% or greater, and the salt blocking ratio is (1−Ci2/Ci1)×100 when the concentration of the salt of the to-be-treated liquid to be treated by using the oil-resistant separation membrane is Ci1 and the concentration of the salt of a permeated liquid obtained after the treatment with the oil-resistant separation membrane is Ci2.

(Appendix 8) The method of treating the oil-containing discharged water, described in any one of Appendixes 1 to 7, is provided, wherein the treatment with the oil-resistant separation membrane is performed under a pressure of 0.3 MPa or greater.

(Appendix 9) The method of treating the oil-containing discharged water, described in any one of Appendixes 1 to 8, includes removing free oil and emulsion oil from the oil-containing discharged water before the treatment with the oil-resistant separation membrane.

(Appendix 10) The method of treating the oil-containing discharged water, described in any one of Appendixes 1 to 9, is provided, wherein the oil-resistant separation membrane includes a porous support layer and a separation function layer provided on the porous support layer, the porous support layer contains one or more polymers selected from a fluoropolymer and an imide-containing polymer, and the compression ratio of a portion that is observed after pressurizing the portion at 5.5 MPa is 60% or less, the portion including the porous support layer and the separation function layer.

(Appendix 11) The method of treating the oil-containing discharged water, described in Appendix 10, is provided, wherein the porosity of the porous support layer observed before the pressurizing is 30% or greater and 70% or less.

(Appendix 12) The method of treating the oil-containing discharged water, described in Appendix 10 or 11, is provided, wherein the one or more polymers in the porous support layer includes a polyvinylidene fluoride homopolymer, a polyvinylidene fluoride copolymer, or a combination thereof.

(Appendix 13) The method of treating the oil-containing discharged water, described in Appendix 12, is provided, wherein the crystallinity of the one or more polymers is 30% or greater and 50% or less.

(Appendix 14) With respect to a method of treating oil-containing discharged water, the method includes treating a to-be-treated liquid containing dissolved oil with an oil-resistant reverse osmosis membrane to remove the dissolved oil and perform desalting simultaneously, the to-be-treated liquid being obtained from oil-containing discharged water.

(Appendix 15) The method of treating the oil-containing discharged water, described in any one of Appendixes 1 to 14, is provided, wherein the dissolved oil contains an aromatic hydrocarbon.

(Appendix 16) The method of treating the oil-containing discharged water, described in Appendix 15, is provided, wherein the aromatic hydrocarbon is one or more of benzene, toluene, ethylbenzene, and xylene.

(Appendix 17) The method of treating the oil-containing discharged water, described in any one of Appendixes 1 to 16, is provided, wherein the to-be-treated liquid is treated with the oil-resistant reverse osmosis membrane without degrading the dissolved oil with an agent.

(Appendix 18) With respect to a method of treating oil-containing discharged water, the method includes treating a to-be-treated liquid containing dissolved oil containing an aromatic hydrocarbon with an oil-resistant reverse osmosis membrane to remove the dissolved oil and perform desalting simultaneously, the to-be-treated liquid being obtained from oil-containing discharged water, wherein the oil-resistant reverse osmosis membrane includes a porous support layer including one or more polymers selected from a fluoropolymer and an imide-containing polymer.

The present application is based upon and claims priority to Japanese Application No. 2020-150765, filed on Sep. 8, 2020, submitted to the Japan Patent Office, the entirety of which is incorporated herein by reference.

### LIST OF REFERENCE NUMERALS

1 separation function layer
2 porous support layer
3 substrate
10 reverse osmosis membrane
12 separation membrane unit
20 separator
30 sedimentation separation unit
40 flotation separation unit
50 sand filtration unit
100 produced water treatment apparatus

1. A method of treating oil-containing discharged water, the method comprising:
treating a to-be-treated liquid containing oil with an oil-resistant separation membrane to remove the oil, the to-be-treated liquid being obtained from the oil-containing discharged water.

2. The method of treating the oil-containing discharged water as claimed in claim 1,
wherein the oil-resistant separation membrane is a reverse osmosis membrane, and the removing of the oil and desalting are performed simultaneously.

3. The method of treating the oil-containing discharged water as claimed in claim 1, wherein the oil is dissolved oil.

4. The method of treating the oil-containing discharged water as claimed in claim 1, wherein a concentration of the oil in the to-be-treated liquid is 0.1 mg/L or greater.

5. The method of treating the oil-containing discharged water as claimed in claim 1, wherein the oil-containing discharged water is one or more of produced water, wash water, and wet air oxidation-treated water.

6. The method of treating the oil-containing discharged water as claimed in claim 1, wherein an oil removal ratio of the oil-resistant separation membrane is 60% or greater, and the oil removal ratio is (1−Co2/Co1)×100, where a concentration of the oil of the to-be-treated liquid to be treated by using the oil-resistant separation membrane is Co1 and a concentration of the oil of a permeated liquid obtained after the treatment with the oil-resistant separation membrane is Co2.

7. The method of treating the oil-containing discharged water as claimed in claim 1, wherein a salt blocking ratio of the oil-resistant separation membrane is 85% or greater, and the salt blocking ratio is (1−Ci2/Ci1)×100 where a concentration of salt of the to-be-treated liquid to be treated by using the oil-resistant separation membrane is Ci1 and the concentration of the salt of a permeated liquid obtained after the treatment with the oil-resistant separation membrane is Ci2.

8. The method of treating the oil-containing discharged water as claimed in claim 1, wherein the treatment with the oil-resistant separation membrane is performed under a pressure of 0.3 MPa or greater.

9. The method of treating the oil-containing discharged water as claimed in claim 1, the method further comprising removing free oil and emulsion oil from the oil-containing discharged water before the treatment with the oil-resistant separation membrane.

10. The method of treating the oil-containing discharged water as claimed in claim 1, wherein the oil-resistant separation membrane includes a porous support layer and a separation function layer provided on the porous support layer, the porous support layer contains one or more polymers selected from a fluoropolymer and an imide-containing polymer, and a compression ratio of a portion that is observed after pressurizing the portion at 5.5 MPa is 60% or less, the portion including the porous support layer and the separation function layer.

11. The method of treating the oil-containing discharged water as claimed in claim 10, wherein porosity of the porous support layer observed before the pressurizing is 30% or greater and 70% or less.

12. The method of treating the oil-containing discharged water as claimed in claim 10, wherein the one or more polymers in the porous support layer includes a polyvinylidene fluoride homopolymer, a polyvinylidene fluoride copolymer, or a combination of the polyvinylidene fluoride homopolymer and the polyvinylidene fluoride copolymer.

13. The method of treating the oil-containing discharged water as claimed in claim 12, wherein crystallinity of the one or more polymers is 30% or greater and 50% or less.

14. A method of treating oil-containing discharged water, the method comprising treating a to-be-treated liquid containing dissolved oil with an oil-resistant reverse osmosis membrane to remove the dissolved oil and perform desalting simultaneously, the to-be-treated liquid being obtained from oil-containing discharged water.

15. The method of treating the oil-containing discharged water as claimed in claim 1, is provided, wherein the dissolved oil contains an aromatic hydrocarbon.

16. The method of treating the oil-containing discharged water as claimed in claim 15, wherein the aromatic hydrocarbon is one or more of benzene, toluene, ethylbenzene, and xylene.

17. The method of treating the oil-containing discharged water as claimed in claim 1, wherein the to-be-treated liquid is treated with the oil-resistant reverse osmosis membrane without degrading the dissolved oil with an agent.

18. A method of treating oil-containing discharged water, the method comprising treating a to-be-treated liquid containing dissolved oil containing an aromatic hydrocarbon with an oil-resistant reverse osmosis membrane to remove the dissolved oil and perform desalting simultaneously, the to-be-treated liquid being obtained from oil-containing discharged water, wherein the oil-resistant reverse osmosis membrane includes a porous support layer including one or more polymers selected from a fluoropolymer and an imide-containing polymer.
